(19) United States
(12) Patent Application Publication
(10) Pub. No.: US 2022/0171438 A1
(43) Pub. Date: Jun. 2, 2022

(54) SCREEN ASSEMBLY STRAIN ALLEVIATION

(71) Applicant: Lenovo (Singapore) Pte. Ltd., Singapore (SG)

(72) Inventors: Kevin Wayne Beck, Raleigh, NC (US); Russell Speight VanBlon, Raleigh, NC (US); Thorsten Peter Stremlau, Morrisville, NC (US)

(21) Appl. No.: 17/108,376

(22) Filed: Dec. 1, 2020

(51) Int. Cl. G06F 1/16; G01L 5/00; F03G 7/06; G05B 15/02

(52) U.S. Cl. CPC G06F 1/1681; G01L 5/00; G06F 1/1616; G05B 15/02; F03G 7/065

(57) ABSTRACT

One embodiment provides a method, including: detecting, using a sensor of an information handling device, a force event directed to a portion of a screen assembly of the information handling device; determining, based on information derived from the sensor, whether the force event exceeds a predetermined strain threshold; and disengaging, responsive to determining that the force event exceeds the predetermined strain threshold, a floating pin from within a hinge mechanism of the information handling device. Other aspects are described and claimed.

### BACKGROUND

Information handling devices (“devices”) having a clamshell design, for example, laptops, notebooks, other hybrid/convertible devices, flip phones, and the like, are generally composed of two sections, i.e., a bottom section and a top section. Conventionally, the bottom section contains one or more input devices (e.g., a keyboard, a trackpad, etc.) whereas the top section contains a primary display screen. The two sections may be connected by at least one hinge mechanism that enables rotation of the top section with respect to the bottom section.

### BRIEF SUMMARY

In summary, one aspect provides a method, comprising: detecting, using a sensor of an information handling device, a force event directed to a portion of a screen assembly of the information handling device; determining, based on information derived from the sensor, whether the force event exceeds a predetermined strain threshold; and disengaging, responsive to determining that the force event exceeds the predetermined strain threshold, a floating pin from within a hinge mechanism of the information handling device.

Another aspect provides an information handling device, comprising: a sensor; a screen assembly; a hinge mechanism; a processor; a memory device that stores instructions executable by the processor to: detect, using the sensor, a force event directed to a portion of the screen assembly of the information handling device; determine, based on information derived from the sensor, whether the force event exceeds a predetermined strain threshold; and disengage, responsive to determining that the force event exceeds the predetermined strain threshold, a floating pin from within the hinge mechanism of the information handling device.

A further aspect provides a product, comprising: a storage device that stores code, the code being executable by a processor and comprising: code detects a force event directed to a portion of a screen assembly of an information handling device; code that determines whether the force event exceeds a predetermined strain threshold; and code that disengages, responsive to determining that the force event exceeds the predetermined strain threshold, a floating pin from within a hinge mechanism.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of lowering a screen assembly to protect it from strain damage.

FIG. 4 illustrates a conventional hinge mechanism and its standard operating process.

FIG. 5 illustrates a resulting effect of a disengagement of a portion of the hinge mechanism in response to strain detection.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Due to their portable nature, clamshell-style devices (“devices”) are often utilized by users in various travel settings. More particularly, it is not uncommon for a user to setup and interact with their laptop or notebook PC while riding on a bus or train or while flying in a plane. While generally not provided with much space in these situations, the slim profiles and adjustable characteristics of these devices enable users to effectively use them even in cramped settings.

Although convenient to have and use while traveling, devices may be more prone to damage in these use cases. For example, an opened laptop positioned on a user's lap while they are riding on a bus may be susceptible to damage when an individual sitting in front of the user reclines their seat back. More particularly, the reclining seat back may exert an undue amount of pressure and force on the screen assembly, thereby potentially causing damage to one or more components of the device (e.g., the screen assembly itself, a hinge mechanism joining the screen assembly to a bottom section of the device, another device component, etc.).

One existing solution may involve use of a sacrificial component (e.g., situated in the hinge mechanism, etc.) that is designed to break at a pre-fabricated weak portion to alleviate strain on the device. However, while effective, such a solution is limited in that it can work only once and may not be able to protect the device if a strain event occurs again. Other solutions are generally proactive in nature. More particularly, a user may caution an individual seated in front of them to lean back carefully because they are working on their device. Additionally or alternatively, a user may ensure that their screen is only opened up to a certain display angle (e.g., less than 90 degrees, etc.), such that damage to the device may be limited if strain is placed on the screen assembly. However, each of these solutions is burdensome and does not ultimately if a sudden strain event does occur.

Accordingly, a method is provided that dynamically implements a damage prevention function on a device responsive to strain detection. In an embodiment, a force event may be detected on a portion of a screen assembly on the device. The force event may correspond to a current or projected strain that is placed on the screen assembly that may cause one or more components associated with the screen assembly to break. An embodiment may then determine whether the force event exceeds a predetermined strain threshold and, responsive to determining that it does, may disengage a floating pin from a hinge mechanism, which thereby causes the screen assembly to lower or drop. Additional details regarding the disengagement process are further provided herein. Such a method may therefore provide certain protections to a device experiencing current or projected strain events.

The illustrated example embodiments will be best understood by reference to the figures. The following description is intended only by way of example, and simply illustrates certain example embodiments.

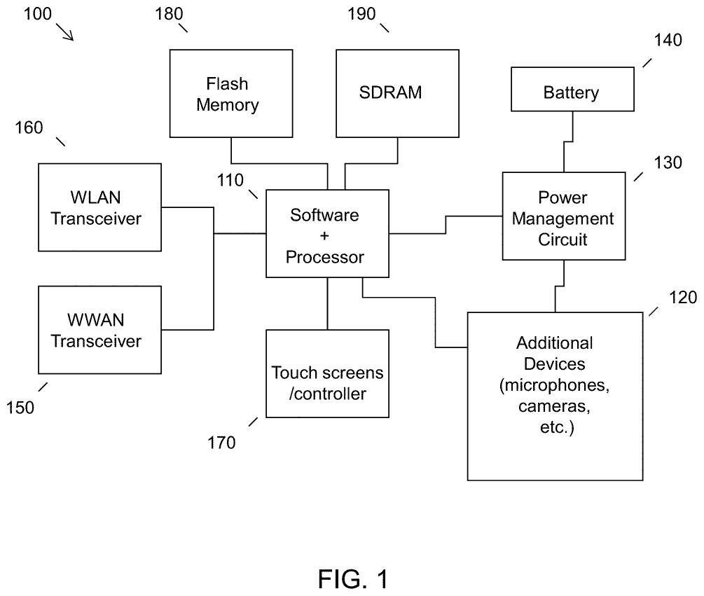

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

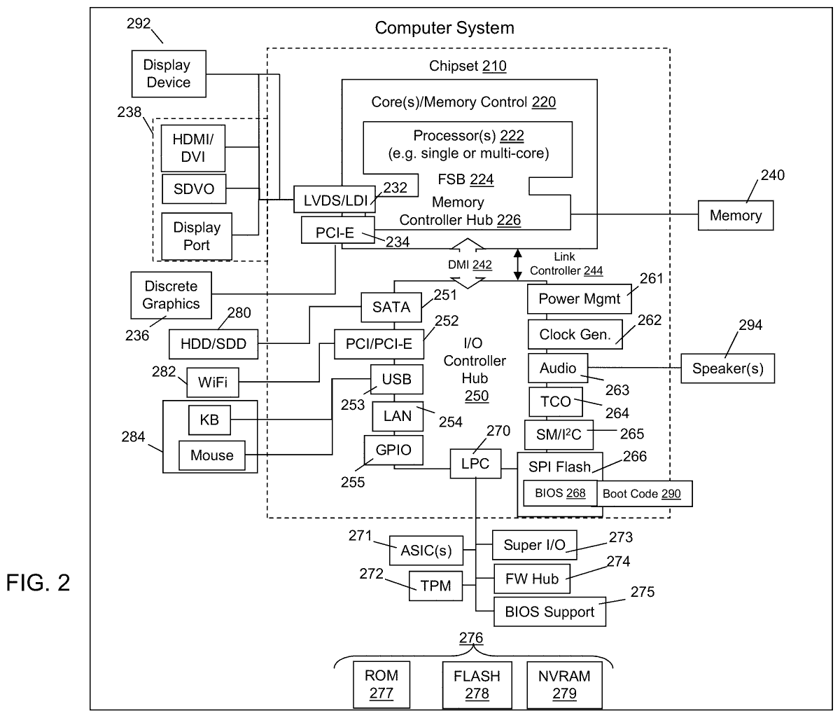

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in clamshell style devices having two sections that are connected by a hinge mechanism. For example, the circuitry outlined in FIG. 1 may be implemented in a smart phone, whereas the circuitry outlined in FIG. 2 may be implemented in a laptop or notebook PC.

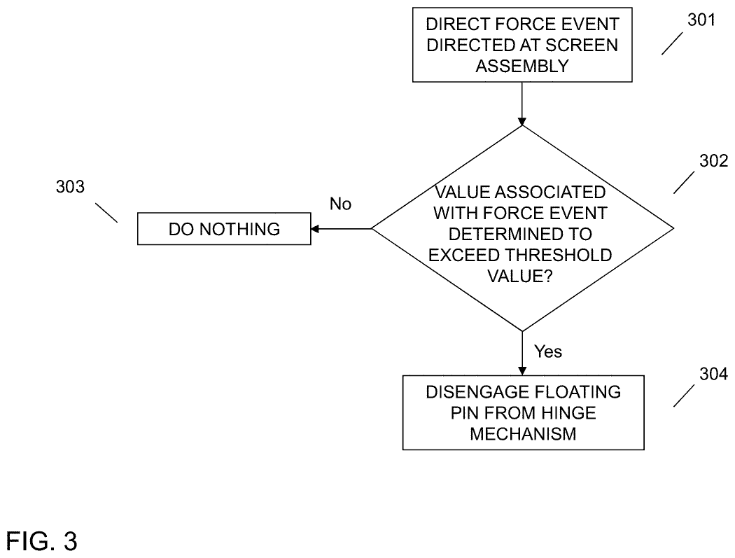

Referring now to FIG. 3, a method for protecting a device against strain events is provided. At 301, an embodiment may detect a force event directed to a portion of a screen assembly of a device. In an embodiment, the screen assembly may correspond to the primary display screen portion of the device (e.g., a top section of a clamshell-style device, etc.). In an embodiment, the force event may be a current or projected force event. More particularly, the former corresponds to a situation where a device is presently undergoing forceful strain whereas the latter corresponds to a situation where the device is imminently expected to undergo forceful strain. The straining force may be detected at virtually any portion of the screen assembly, however, as one example, the straining force may be a force directed to a top portion of the screen assembly (e.g., directed to an upper portion of a display screen, directed on top of a bezel surrounding the display screen, etc.).

In an embodiment, the detection of the force event may be facilitated using one or more different sensors integrated into the device. For example, one or more strain gauges (e.g., one or more resistive strain gauges, one or more piezeoelectric sensors, etc.) may be positioned on the top and/or upper portions of the screen assembly (e.g., around the top bezel of the screen assembly, etc.). These strain gauges may be able to detect and record a current strain that the screen assembly is experiencing. Additionally or alternatively, as another example, at least one camera and/or proximity sensor may be integrated into the device that may be able to detect an incoming strain to the screen assembly. For example, a proximity sensor may detect when an object is within a predetermined distance of the device and/or is approaching the device at a predetermined rate. In a similar example, a camera sensor (e.g., an always-on camera, etc.) may be able to determine that a particular object is approaching.

At 302, an embodiment may determine whether the force event will exceed a predetermined strain threshold based upon strain information derived from the sensors. In an embodiment, the predetermined strain threshold may correspond to a threshold at which an embodiment concludes that further strain directed to the screen assembly may damage one or more components of the device. In an embodiment, the predetermined strain threshold may originally be set by a manufacturer of the device. Additionally or alternatively, the predetermined strain threshold may later be manually (e.g., by a device user, etc.) or dynamically adjusted. Regarding the latter, an embodiment may dynamically adjust the threshold based upon one or more types of available context data (e.g., environmental data, ambient audio data, location data, movement data, activity data, etc.). For example, responsive to receiving an indication from a user's calendar that they are scheduled to travel on a plane during a particular time of day, an embodiment may increase the sensitivity of the threshold during that time period in order to provide strain protections for the device if it is used. As another example, an embodiment may increase the sensitivity of the threshold responsive to concluding from movement data (e.g., accelerometer data, gyroscopic data, etc.) that a device is being operated within a moving vehicle.

In an embodiment, the determination process may be based upon whether actual or projected strain is detected and also based upon the type of sensors utilized in the determination. For instance, if actual strain is detected by one or more strain gauges, an embodiment may record a strain value output by the relevant strain gauge and compare that value to a predetermined threshold value (e.g., located in an accessible storage database, etc.). Alternatively, as another example, if a camera sensor and/or proximity sensor is utilized to project incoming strain, an embodiment may be able to determine one or more characteristics of an approaching object (e.g., object identity, object size, object distance to screen assembly, object approach rate, etc.) and assign a strain value to the approaching object based upon at least one of these characteristics. An embodiment may thereafter compare the assigned strain value to a predetermined threshold value to determine whether the approaching object will produce a strain on the screen assembly that may demand a protective action to be taken.

Responsive to determining, at 302, that a value associated with the force event will not exceed a predetermined threshold value, an embodiment may, at 303, take no additional action. Conversely, responsive to determining, at 303, that a value associated with the force event will exceed a predetermined threshold value, an embodiment may, at 304, dynamically take a protective measure to minimize the potential damage to the screen assembly, another device component, or the device as a whole. The protective measure(s) employed by a system of the device will be described in the following paragraphs in more details.

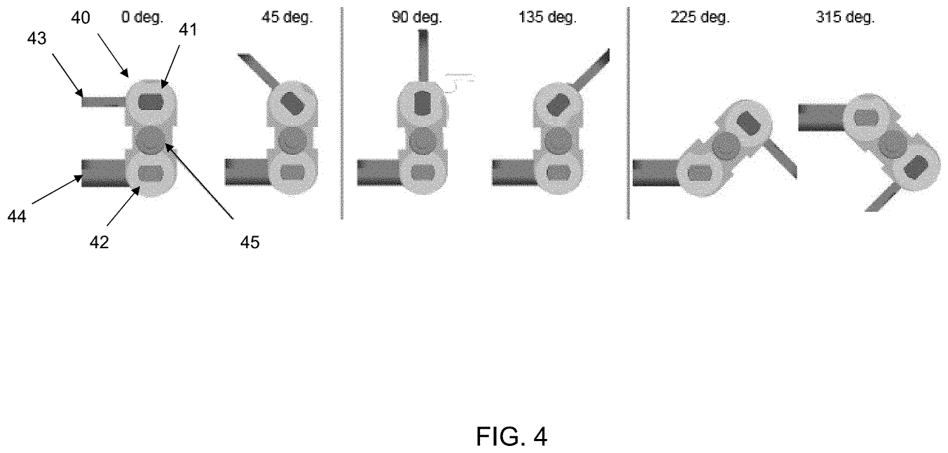

In an embodiment, the screen assembly of the device may be connected to a bottom section of the device by at least one hinge mechanism. Referring now to FIG. 4, an illustration of a conventional 360-degree rotating hinge mechanism and its standard operation process is provided. The illustration shows a hinge mechanism 40 that contains two pivot points (i.e., two cams) 41, 42 that may rotate within the hinge mechanism 40 and may facilitate angular movement of the top section 43 (i.e., the screen assembly) with respect to the bottom section 44 of the device. As can be seen from the illustration, as the degree angle of the top section 43 is increased, the hinge mechanism 40 may gradually rotate down correspondingly. More particularly, through 135 degrees of rotation the upper cam 41 may rotate around itself and a floating pin 45 may be locked to the bottom cam 42, which prevents the bottom portion of the hinge mechanism 40 from rotating. Between 135 degrees and 180 degrees, the floating pin 45 may disengage from the bottom cam 42 and may subsequently be secured to the upper cam 41, thereby allowing downward rotation of the hinge mechanism 40 through the remainder of the rotation angles (i.e., through 360 degrees of rotation).

Undue stress placed on the screen assembly may break one or more of the previously described components within the hinge mechanism. Accordingly, responsive to determining that a value associated with a force event is greater than a predetermined threshold value, an embodiment may implement a process that disengages the floating pin from its locked position, thereby allowing the hinge mechanism to quickly fall/rotate down so that the stress placed on the screen assembly may be alleviated.

In an embodiment, responsive to receiving an indication that a value associated with the force event is greater than a predetermined threshold value, an embodiment may utilize a controller integrated into the device to transmit a state change indication to a shape-memory metal alloy (“memory metal”) actuator associated with the hinge mechanism. In an embodiment, the state change indication may correspond to one or more of a signal or a voltage. More particularly, the controller may send a signal or voltage to the memory metal actuator in response to a positive strain determination. Responsive to receiving this signal or voltage, the memory metal actuator may disengage the floating pin from its locked state, as further described below, and may therefore allow a downward rotation of the hinge mechanism.

In the context of this application, a memory metal corresponds to a metal alloy (e.g., copper-aluminum-nickel alloy, nickel-tin alloy, etc.) that may return to its original shape, subsequent to shape manipulation, in response to one or more of: a heating event or a cooling event. In an embodiment, the floating pin utilized in the hinge mechanism may be a memory metal and/or another component within the hinge mechanism in contact with the floating pin may be a memory metal. Regarding the former, when a signal or voltage is received at the memory metal actuator, the floating pin may be heated which may subsequently facilitate a shape transformation (e.g., to an original shape, etc.). This transformation may correspondingly adjust a position of the floating pin and unlock the floating pin from the hinge mechanism. For example, when heated the floating pin may contract in size (i.e., revert to its original shape), thereby unlocking the hinge mechanism. With respect to the ladder, another component within the hinge mechanism may be composed of a memory metal and its shape transformations may affect a positioning of the floating pin within the hinge mechanism.

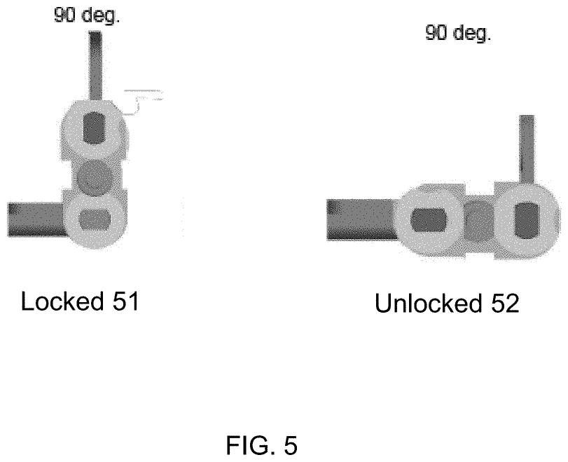

Referring now to FIG. 5, an illustration of the effect of the foregoing concepts is provided. More particularly, FIG. 5 presents two implementations of the hinge mechanism described above, one in which the floating pin is engaged (i.e., when the hinge mechanism is in a locked state 51) and the other in which the floating pin is disengaged (i.e., in an unlocked state 52). In each configuration, the screen assembly is substantially oriented in a 90 degree position. As can be seen from the figure, unlocking the floating pin enables the hinge mechanism to rotate downward, which correspondingly also lowers a vertical position of the screen assembly (e.g., by about an inch, etc.). The effect of this lowering may serve to alleviate stress, or projected stress, directed to a portion of the screen assembly.

In an embodiment, the floating pin may only be disengaged from the hinge mechanism if a screen angle of the screen assembly is greater than a predetermined screen angle (e.g., 90 degrees, etc.). The processes described above may not be implemented when the screen angle is determined to be less than the predetermined screen angle because those angles may generally be associated with “safe” screen angles to receive strain. In another embodiment, once disengaged the floating pin may be reset to its locked position to revert the hinge mechanism to its standard operation protocol. In an embodiment, resetting the floating pin may involve transmitting another state change indication to the memory metal actuator, which may thereafter affect a shape of the floating pin (e.g., elongate it, etc.) or affect a shape of another hinge component in contact with the floating pin that enables the floating pin to re-engage the hinge mechanism in a locked state.

The various embodiments described herein thus represent a technical improvement to conventional methods for alleviating strain on a device. Using the techniques described herein, an embodiment may detect a force event directed to a screen assembly that may place undue strain on the screen assembly and/or another component of the device. An embodiment may thereafter determine whether the force event will exceed a predetermined strain threshold and, responsive to determining that it will, may initiate a strain alleviation process in which a floating pin that secures a hinge mechanism disengages, thereby enabling the hinge mechanism to rotate downward and alleviate the strain placed on the screen assembly.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, using a sensor of an information handling device, a force event directed to a portion of a screen assembly of the information handling device;
determining, based on information derived from the sensor, whether the force event exceeds a predetermined strain threshold; and
disengaging, responsive to determining that the force event exceeds the predetermined strain threshold, a floating pin from within a hinge mechanism of the information handling device.

2. The method of claim 1, wherein the sensor comprises a strain gauge positioned on the screen assembly.

3. The method of claim 1, wherein the sensor is selected from the group consisting of: at least one camera and at least one proximity sensor;
wherein the force event is an impending force event.

4. The method of claim 1, further comprising dynamically adjusting the predetermined strain threshold based upon context data.

5. The method of claim 4, wherein the context data comprises data selected from the group consisting of environmental data, ambient audio data, location data, movement data, and activity data.

6. The method of claim 1, wherein the disengaging comprises:
transmitting, from a controller of the information handling device, a state change indication to a shape-memory metal actuator associated with the hinge mechanism; and
adjusting, upon receipt of the state change indication, a position of the floating pin.

7. The method of claim 1, further comprising resetting the position of the floating pin responsive to receiving a state change indication from the controller.

8. The method of claim 1, wherein the adjusting the position comprises manipulating a shape of the floating pin.

9. The method of claim 1, wherein the disengaging the floating pin enables a downward rotation of the hinge mechanism.

10. The method of claim 1, wherein the disengaging comprises disengaging only when a screen angle of the screen assembly is greater than a predetermined threshold angle.

11. An information handling device, comprising:
a sensor;
a screen assembly;
a hinge mechanism;
a processor;
a memory device that stores instructions executable by the processor to:
detect, using the sensor, a force event directed to a portion of the screen assembly of the information handling device;
determine, based on information derived from the sensor, whether the force event exceeds a predetermined strain threshold; and
disengage, responsive to determining that the force event exceeds the predetermined strain threshold, a floating pin from within the hinge mechanism of the information handling device.

12. The information handling device of claim 11, wherein the sensor comprises a strain gauge positioned on the screen assembly.

13. The information handling device of claim 11, wherein the sensor is selected from the group consisting of: at least one camera and at least one proximity sensor;
wherein the force event is an impending force event.

14. The information handling device of claim 11, wherein the instructions are further executable by the processor to dynamically adjust the predetermined strain threshold based upon context data;
wherein the context data comprises data selected from the group consisting of environmental data, ambient audio data, location data, movement data, and activity data.

15. The information handling device of claim 11, wherein the instructions executable by the processor to disengage comprise instructions executable by the processor to:
transmit, from a controller of the information handling device, a state change indication to a shape-memory metal actuator associated with the hinge mechanism; and
adjust, upon receipt of the state change indication, a position of the floating pin.

16. The information handling device of claim 11, wherein the instructions are further executable by the processor to reset the position of the floating pin responsive to receiving a state change indication from the controller.

17. The information handling device of claim 11, wherein the instructions executable by the processor to adjust the position comprise instructions executable by the processor to manipulate a shape of the floating pin.

18. The information handling device of claim 11, wherein the instructions executable by the processor to disengage the floating pin enable a downward rotation of the hinge mechanism.

19. The information handling device of claim 11, wherein the instructions executable by the processor to disengage comprise instructions executable by the processor to disengage only when a screen angle of the screen assembly is greater than a predetermined threshold angle.

20. A product, comprising:
a storage device that stores code, the code being executable by a processor and comprising:
code detects a force event directed to a portion of a screen assembly of an information handling device;
code that determines whether the force event exceeds a predetermined strain threshold; and
code that disengages, responsive to determining that the force event exceeds the predetermined strain threshold, a floating pin from within a hinge mechanism.
